(19) United States
(12) Patent Application Publication
(10) Pub. No.: US 2025/0271671 A1
(43) Pub. Date: Aug. 28, 2025

(54) AUGMENT GLASS SYSTEM TO DYNAMICALLY ADJUST AN AUGMENTED REALITY OBJECT IN VIEW OF A USER

(71) Applicant: Luminary, LLC DBA Luminary Design Co., Baton Rouge, LA (US)

(72) Inventors: Brian James Beyt, Baton Rouge, LA (US); Ren Eric Simmons, Austin, TX (US); Camille Simone Wetekamm, Baton Rouge, LA (US)

(73) Assignee: Luminary, LLC DBA Luminary Design Co., Baton Rouge, LA (US)

(21) Appl. No.: 19/185,103

(22) Filed: Apr. 21, 2025

Related U.S. Application Data
(60) Provisional application No. 63/556,939, filed on Feb. 23, 2024.

(51) Int. Cl. G02B 27/01; G06F 3/0488

(52) U.S. Cl. CPC G02B 27/017; G06F 3/0488

(57) ABSTRACT

An augment glass system to display a digital content that adjusts dynamically in real-time on an active transparent display in communication with a custom sensor housing. Furthermore, the custom sensor housing includes a user sensor to capture a sensor data of a user and an object sensor to capture a sensor data of an object. Further, the augment glass system is configured to process data obtained from the user sensor and the object sensor, determining user coordinates and object coordinates via one or more processing units, and displaying the digital content on the active transparent display. The augment glass system further includes the ability to average the input data of multiple users to optimize the digital content displayed on the active transparent display. The augment glass system also includes integrating a plurality of augment glass systems via a processing circuitry and a cloud network.

### CROSS-REFERENCE TO RELATED APPLICATIONS

This application claims priority to and the benefit of U.S. Provisional Utility Patent Application No. 63/556,939, filed Feb. 23, 2024, which is incorporated herein by reference.

### TECHNOLOGICAL FIELD OF THE INVENTION

The present invention generally pertains to the field of augmented reality and, in particular relates to, a system for dynamically adjusting an augmented reality object in view of a user and methods thereof.

### BACKGROUND OF THE INVENTION

The realm of display technologies has undergone significant transformations over the years, fundamentally altering how individuals interact with and perceive information and digital content in both commercial and residential settings. Conventional display systems, while advantageous in many scenarios, often introduce visual impediments that can hinder the immersive experience of digital content, as it merges with the tangible environment. Furthermore, the traditional interactive modalities, such as touchscreens or peripheral input devices, constrain users' natural engagement with content, often limiting the perception of the digital realm as an extension of the physical world.

Therefore, there is a need to develop effective solutions to integrate and merge digital content with tangible environments in an immersive way.

### DESCRIPTION OF THE RELATED ART

In the burgeoning fields of augmented reality (AR) and mixed reality (MR), achieving a seamless integration of digital content with the physical space poses a series of challenges. Conventional AR systems and MR systems typically depend on handheld devices or head-mounted displays to project digital overlays. These approaches can create barriers that disrupt user immersion and restrict the breadth of interaction. Additionally, existing AR and MR frameworks often grapple with accurately accommodating digital content as users navigate their physical surroundings, resulting in a disjointed user experience.

The introduction of transparent display technologies, such as Transparent Organic Light Emitting Diodes (T-OLED) and Transparent Light Emitting Diodes (T-LED), has emerged as a promising advancement, allowing for the creation of immersive and unobtrusive AR experiences. These innovative displays provide a clear view of both the digital content and the physical world behind them.

However, the true potential of transparent displays in the context of augmented reality remains largely untapped. Current applications have enabled digital content to animate over physical objects positioned behind the display; yet they often lack the sophisticated real-time user tracking necessary to deliver a convincing three-dimensional AR and/or MR experience.

These above deficiencies highlight a pressing need for an advanced solution capable of dynamically adjusting digital content according to user movements and gaze, thereby fostering meaningful interactions without compromising user engagement with the surrounding environment.

### SUMMARY OF THE INVENTION

It is one prospect of the present invention to address the above challenges, the present disclosure provides for an “Augment Glass System” solution that intricately merges digital content with the physical realm by harnessing the capabilities of active transparent display technologies, integrated computer vision sensors or other sensing technology, and bespoke perspective tracking software. The present disclosure provides versatile AR and/or MR solutions, to augment digital content or in some cases enabling physical objects located behind one or more displays to be cohesively connected to the digital content. Additionally, it offers the ability to exhibit three-dimensional digital assets in a manner that renders them as realistic floating holograms dynamically adjusting on the display in real-time for the user, thus enhancing user immersion and interaction without disrupting the user's experience within the physical world.

According to an aspect of the present invention, the present embodiments provide a method to dynamically adjust a digital content in view of a user. The method steps include capturing sensor data of a user via the user sensor and, in some use cases, sensor data of an object via an object sensor. Further, the method steps include processing the sensor data and/or other data obtained from the user sensor and the object sensor, and determining user coordinates and object coordinates via one or more processing units. Additionally, the method steps include displaying the digital content on an active transparent display in a manner that is adjusted to the physical position of the user and/or the object. As the data collected by the input sensing devices changes, the position of the digital content changes, adapting in real-time to the physical position of the user and/or object.

In some additional, alternative, or selectively cumulative embodiments, the user sensor and the object sensor include an infrared camera or a face mapping module. Furthermore, the one or more processing units compile the received sensor data to identify user details and object details. Correspondingly, in some cases, determining the user coordinates includes calculating the distance between a global coordinate and the user, and determining an average user point coordinate based on a left eye and a right eye of the user. Alternative embodiments include calculating the user point coordinate via other input sensing devices and processing methods. The average user point coordinate is the user coordinates for tracking the user. Moreover, determining the object coordinates further include calculating the distance between global coordinates and the object, and determining an average object point coordinate based on height, width, and length of the object. The average object point coordinates are the object coordinates for tracking the object.

In some additional, alternative, or selectively cumulative embodiments, the one or more processing units may be further configured to calculate an angle of tilt or pitch angle at least based on a height of a hardware platform and a height of the user coordinates. The one or more processing units may further orient the digital content at least based on the real-time user coordinates and display the digital content on the active transparent display.

In some additional, alternative, or selectively cumulative embodiments, the active transparent display may include a plurality of diodes for projecting the digital content based on user coordinates. Further, the augment glass system may include a touch interface integrated into the active transparent display for interactive use by the user.

According to another aspect of the present invention, an augment glass system to dynamically adjust the digital content in view of a user is disclosed. The augment glass system comprises a plurality of sensors located in a custom sensor housing. The custom sensor housing includes a user sensor adapted to capture sensor data of the user and an object sensor adapted to capture sensor data and/or other data of the object. The custom sensor housing is custom-built for different embodiments of the Augment Glass system to meet any physical requirements, including but not limited to the height of the hardware platform, the height of the user, the distance of the user from the user sensor, the distance of the object from the object sensor, the angle (pitch or yaw) of the user from the user sensor, and the angle (pitch and yaw) of the object from the object sensor. Further, the one or more processing units may be configured to process the sensor data and/or other data obtained from the user sensor and the object sensor, determine user coordinates and object coordinates via the one or more processing units, and display the digital content on the active transparent display.

In some additional, alternative, or selectively cumulative embodiments, the custom sensor housing may be a modular attachment mounted on or near the augment glass system, including but not limited to the hardware platform and the active transparent display. Further, the user sensor and the object sensor may include a camera or secondary input sensing device to capture data of the user and the object.

In some other additional, alternative, or selectively cumulative embodiments, the user sensor and the object sensor include an infrared camera or a face mapping module. Further, the one or more processing units compile the received sensor data to identify user details and object details. The user coordinates may be determined by calculating the distance between a global coordinate and the user then determining an average user point coordinate based on a left eye and a right eye of the user. The average user point coordinate is the user coordinates for tracking the user. Determining the object coordinates may further include calculating the distance between a global coordinate and the object, and then determining an average object point coordinate based on height, width, and length of the object. The average object point coordinate is the object coordinates for tracking the object.

In some more additional, alternative, or selectively cumulative embodiments, the active transparent display may include a plurality of diodes for projecting the digital content based on user coordinates. Further, the active transparent display may include a touch interface for the user.

In some additional, alternative, or selectively cumulative embodiments, a processing circuitry includes one or more processing units that communicate via a communication device with a cloud network. Further, the cloud network includes a server for processing the rendering of the digital content to display on the active transparent display.

According to another aspect of the present invention, an augment glass system for dynamically adjusting a digital content in view of a user is disclosed. The augment glass system may include a hardware platform to house an active transparent display, a custom sensor housing, additional equipment, and any other hardware or element of each embodiment. The augment glass system comprises a custom sensor housing operatively connected to the active transparent display. Further, the custom sensor housing includes a user sensor to capture sensor data of the user and an object sensor to capture sensor data of an object. Further, the augment glass system comprises one or more processing units operatively coupled to the user sensor and the object sensor configured to process the sensor data of the user obtained from the user sensor to determine real-time user coordinates using a computer vision engine. Further, the one or more processing units are configured to process the sensor data of the object obtained from the object sensor to determine real-time object coordinates using the computer vision engine. Even further, the one or more processing units are configured to calculate an angle of tilt or pitch angle based at least on a height of the hardware platform and a height of the user coordinates and dynamically adjust and orient the digital content displayed on an active transparent display based on real-time user coordinates in response to changes in the user coordinates.

In some additional, alternative, or selectively cumulative embodiments, a plurality of augment glass systems for dynamically adjusting the digital content is presented. Each of the plurality of augment glass systems may operate in combination adjusting correlated digital content on each of the active transparent displays. In another embodiment, each of the plurality of augment glass systems may operate independently of each other, adjusting the digital content on each of the active transparent displays independently of each other. Each of the plurality of augment glass systems includes a processing circuitry including one or more processing units. The processing circuitry of each of the plurality of augment glass systems is configured to communicate with at least one other processing circuitry of the plurality of augment glass systems via a communication device to a cloud network. The cloud network includes a server for processing the rendering of the digital content to display on each of the augment glass systems' active transparent displays, which may be optionally correlated with each other or independent uncorrelated digital content.

### BRIEF DESCRIPTION OF DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. Having thus described example embodiments of the invention in general terms, illustrative embodiments of the present invention are described herein with reference to the accompanying drawings, for which the components in the figures are not necessarily to scale, emphasis instead being placed upon illustrating principles, and wherein:

FIG. 1 illustrates a top right schematic representation view of an augment glass system to dynamically adjust an augmented reality object in view of a user, in accordance with an embodiment of the disclosure;

FIG. 2 illustrates a top right schematic representation view of the augment glass system to track user coordinates and object coordinates, in accordance with an embodiment of the disclosure;

FIG. 3 illustrates a sequence diagram that depicts a method to dynamically adjust the digital content in view of the user, in accordance with an embodiment of the disclosure;

FIG. 4 illustrates a right side elevation schematic representation view of the augment glass system to track an angle of the user coordinates and an object coordinates, in accordance with an embodiment of the disclosure;

FIG. 5 illustrates a front elevation schematic representation view of the augment glass system showing an active transparent display, in accordance with an embodiment of the disclosure;

FIG. 6A, illustrates a front elevation schematic representation of an augment glass system showing the active transparent display, in accordance with an embodiment of the invention;

FIG. 6B, illustrates a top right oblique perspective view of the augment glass system showing the active transparent display, in accordance with an embodiment of the disclosure;

FIG. 7 illustrates a block diagram of a processing circuitry, in accordance with an embodiment of the disclosure;

FIG. 8, illustrates an information flow diagram of the augment glass system, in accordance with an embodiment of the present invention; and

FIG. 9 illustrates a block diagram of the augment glass system communicating on a cloud network, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure. Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations (e.g. portrait or landscape) in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

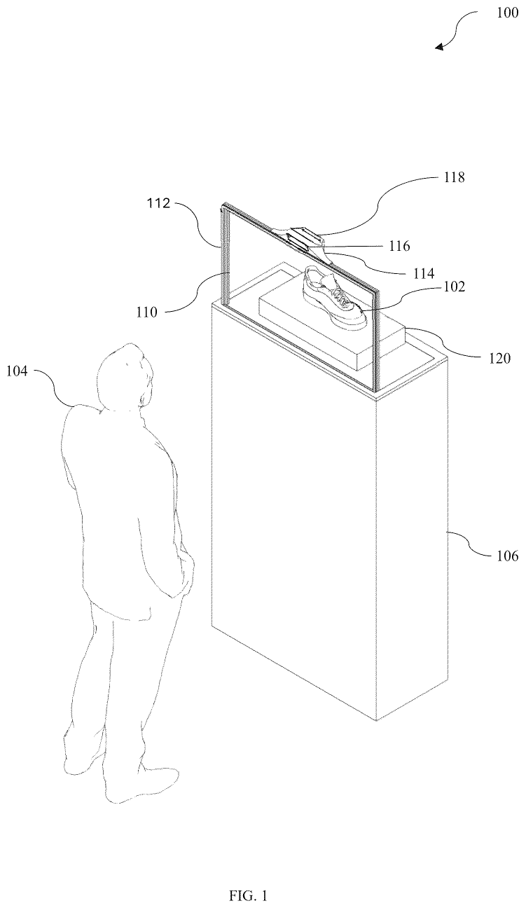

Referring initially to FIG. 1, a top right schematic representation of an augment glass system 100 to dynamically adjust an augmented reality object 102 in view of a user 104 is illustrated, in accordance with an embodiment of the disclosure. The augment glass system 100 includes various equipment; for example, the augment glass system 100 includes a hardware platform 106 for housing various components essential for augmenting the object 102 to provide an interactive experience to the user 104. The hardware platform 106 may be an elevated structure to compensate for height of the user 104. In another embodiment, the hardware platform 106 may be adjustable (e.g. vertically) at least based on the height of the user 104. The hardware platform 106 may be adjusted at least via a plurality of motors (not shown). For example, the augment glass system 100 may detect the user 104 approaching towards the hardware platform 106 and automatically adjust the height of the hardware platform 106 to provide an optimal viewing angle of the digital content overlaid on the object 102, via augmented reality, to the user 104.

The augment glass system 100 further includes one or more input sensors (not shown). The one or more input sensors are adapted to detect the presence of the user, their gesture, their voice, or any other parameters associated with the user 104. The one or more input sensors may further automatically trigger an interactive application or any additional digital or physical effect on or behind an active transparent display 110. The augment glass system 100 may be controlled via touch, proximity gesture, voice, and/or an input device, such as a keyboard configured to interact with the interactive application.

The augment glass system 100 may be configured to determine a suitable perspective view for the user 104. Further, as mentioned above, the augment glass system 100 may be configured to adjust the height of the hardware platform 106 via the plurality of motors. In yet another embodiment, the hardware platform 106 may be capable of rotating into view of the user 104 approaching the hardware platform 106. For example, the hardware platform 106 may be rotated via a secondary set of motors (also not shown).

In an embodiment, the hardware platform 106 may house the active transparent display 110. For example, the active transparent display 110 may be mounted on a top of the hardware platform 106. In another embodiment, the active transparent display 110 may be mounted on sides of the hardware platform 106. The hardware platform 106 may house one or more active transparent display 110 connected to a single augment glass system 100. The one or more active transparent display 110 may be configured to display a single digital content (not shown) or may be configured to display multiple independent digital content. The active transparent display 110 presents the digital content for the user 104. The active transparent display 110, for example, may be made of glass, polycarbonate, acrylic, ionomer resin or any other suitable material. In yet another embodiment, the active transparent display 110 may include a frame 112 on its periphery to protect the active transparent display 110 from physical damage. In an exemplary embodiment, the active transparent display 110 may be retractable into the hardware platform 106 via a tertiary set of motors (not shown). Further, the active transparent display 110 may be bendable at certain angles to create an immersive experience for the user 104.

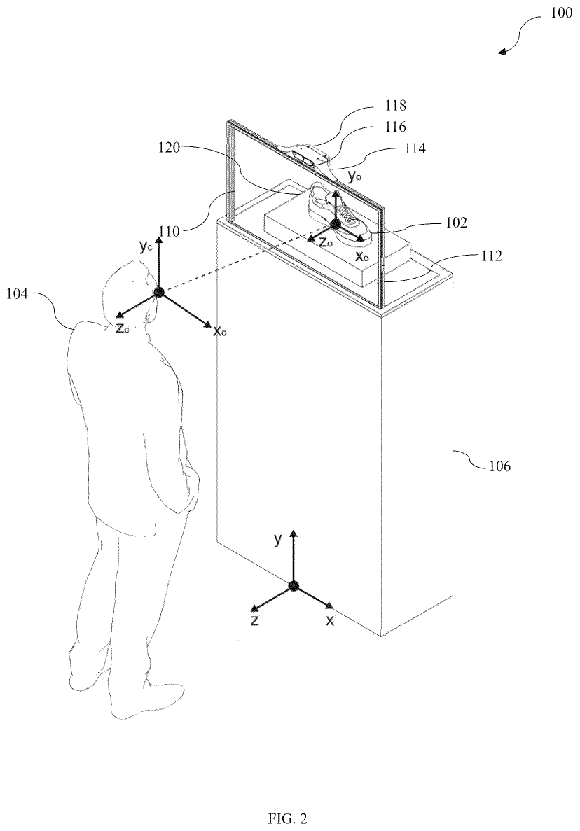

The augment glass system 100 may include a custom sensor housing 114, as shown in FIG. 1. The custom sensor housing 114 may be installed at a predetermined position to accurately capture sensor data. The custom sensor housing 114 may be a detachable module which can be fixed on any location on the active transparent display 110, the hardware platform 106, or anywhere on or around the augment glass system 100. In an embodiment, the custom sensor housing 114 may include one or more sensors such as a user sensor 116. The user sensor 116 is configured to detect the user 104 approaching, which is explained in detail with reference to FIG. 2. The user sensor 116 may communicate electrically the presence of the user 104, to activate the digital content displayed via the active transparent display 110. Further, the custom sensor housing 114 may include one or more sensors such as an object sensor 118. The object sensor 118 may be configured to detect an object 102, which is explained in detail, with reference to FIG. 2. The object sensor 118 may provide the coordinates of the object 102 to overlay the digital content displayed on the active transparent display 110. The object 102, for example, may be a physical object which is placed on the other side of the active transparent display 110. The user sensor 116 and the object sensor 118 may track the coordinates of the user 104 and the object 102 in real-time. Thus, the active transparent display 110 may adjust the digital content at least based on the updated coordinates shared by the user sensor 116 and object sensor 118.

In another embodiment, during operation, the object 102 may be placed on an object platform 120. The object platform 120 may be a fixed platform or a rotatable platform. In an exemplary embodiment, the object platform 120 may be retractable into the hardware platform 106 via a quaternary set of motors (not shown). If the object 102 is not required for the digital content, the object platform 120 may remain inside (retracted into) the hardware platform 106 and, when the object 102 is required, the object platform 120 can be extended outwards from the object platform 120.

Now turning to FIG. 2, a top right schematic representation of the augment glass system 100 is illustrated, for tracking user coordinates and object coordinates, in accordance with an embodiment of the disclosure. FIG. 2 is explained in conjunction with elements of FIG. 1. The augment glass system 100, as depicted in FIG. 2, may be configured to calculate the coordinates as a reference to display the digital content shown in FIG. 1. The user sensor 116 may include a camera (not shown) to capture data of the user 104. The user sensor 116 may transmit the captured data to one or more processing units (not shown). The one or more processing units may utilize a computer vision engine (not shown) to detect the exact position of all users in its field of vision. The one or more processing units may determine the user coordinates in a three-dimensional shape, such as x_{c}, y_{c}, z_{c}. The user coordinates may be calculated in reference to the global coordinates, such as x, y, z. The global coordinates may be associated with the hardware platform 106 or any other predefined location within the physical space of the augment glass system 110. In one embodiment, the one or more processing units may be configured to average the user coordinates at least based on a distance between a left eye (not shown) and a right eye (not shown) of the user 104. Further, the user coordinates may be used as a reference point for the active transparent display 110 to display the digital content.

In another embodiment, the user sensor 116 may be configured to continuously track the user coordinates corresponding to any change in the relative position of the digital content. Further, the one or more processing units may be configured to display the digital content, at least as per the updated user coordinates in real-time.

In an additional embodiment, the user sensor 116 may be configured to track one or more users 104. The one or more processing units may be configured to calculate the user coordinates of one or more users 104. The one or more processing units may average the user coordinates to display the digital content on the active transparent display 110. The averaging of the user coordinates may be done to provide an optimized view of the digital content for each and all of the group of users 104.

When the object 102 is present for the reference of the digital content, the object sensor 118 may be activated to determine the object coordinates. In yet another embodiment, the object sensor 118 may include a camera to capture data of the object 102. The object sensor 118 may transmit the captured data to one or more processing units. The one or more processing units may determine the object coordinates in a three-dimensional shape such as xₒ, yₒ, zₒ. The object coordinates may be calculated in reference to the global coordinates such as x, y, z and to the user coordinates x_{c}, y_{c}, z_{c}. The global coordinates may be associated with the hardware platform 106.

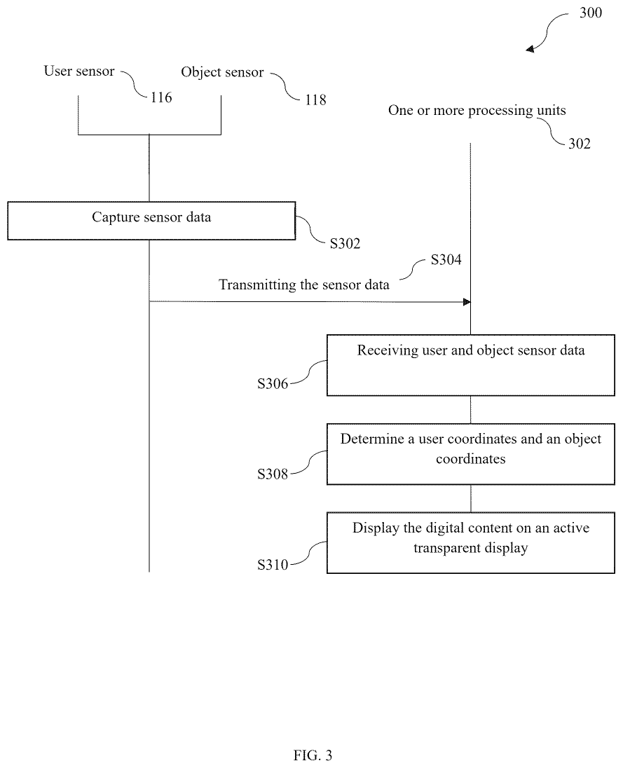

Referring now to FIG. 3, a sequence diagram is illustrated that depicts a method 300 to dynamically adjust the digital content in view of the user 104, in accordance with an embodiment of the present invention. FIG. 3 is explained in conjunction with elements of FIG. 1 and FIG. 2. The augment glass system 100, as depicted in FIG. 1 and FIG. 2, may be configured to implement the method 300 as shown in FIG. 3. As mentioned above, the user sensor 116 and the object sensor 118 are in communication with one or more processing units 302. In an exemplary embodiment, the one or more processing units 302 may be installed in the custom sensor housing 114 or in the hardware platform 106. In another exemplary embodiment, the one or more processing units 302 may be installed on a cloud network (not shown). The user sensor 116 and the object sensor 118 may directly send the data to the cloud network. In yet another exemplary embodiment, the one or more processing units 302 may be installed on an external computing device (not shown). Further, the sequence diagram of FIG. 3 depicts one or more operations performed by one or more processing units 302, to display the digital content on the active transparent display 110, as elaborated below.

At step S302, sensor data related to the user 104 may be captured via the user sensor 116. Further, at step S302, the sensor data related to the object 102 may be captured via the object sensor 118. The sensor data and/or other data may be of a format selected from AVI, MP4, MGP, MOV, 3GP, WMV, etc. In an embodiment, the user sensor 116 and object sensor 118 may be incorporated with an infrared camera or a face mapping module. At step S304, the sensor data may be transmitted to the one or more processing units 302. In an exemplary embodiment, the sensor data may be transmitted wirelessly or may be transmitted via a wired connection to the one or more processing units 302.

At step S306, the one or more processing units 302 may process the sensor data obtained from the user sensor 116 and the object sensor 118. The one or more processing units 302 may be configured to compile the sensor data. In another exemplary embodiment, the one or more processing units 302 may compile the received sensor data to identify the user details and the object details. The user details and the object details may be a combination of a plurality of parameters, such as height, face direction, or eye movements, etc. It may be noted that the plurality of parameters may be analyzed by a third party software or on cloud servers.

At step S308, the one or more processing units 302 may determine the user coordinates and the object coordinates. In yet another embodiment, the user coordinates may be determined by calculating the distance between the global coordinates and the user 104. In one implementation, the one or more processing units 302 may determine distance between the eyes of the user 104. The distance between the left eye and the right eye may be calculated to generate an average user point coordinate. The average user point coordinates may further be represented as the user coordinates to effectively track the user 104. It may be noted that the one or more processing units 302 may track one or more users 104 while displaying the digital content. In an additional embodiment, the object coordinates may be calculated in reference to the global coordinates and the object 102. To this end, the one or more processing units 302 may determine the average object coordinates, at least based on height, width, and length of the object 102. The average object point coordinates may be represented as the object coordinates for tracking the object 102.

At step S310, the one or more processing units 302 may display the digital content on the active transparent display 110. The one or more processing units 302 may orient the digital content at least based on the real-time user coordinates. In an exemplary embodiment, the one or more processing units 302 may overlay the digital content on the object 102.

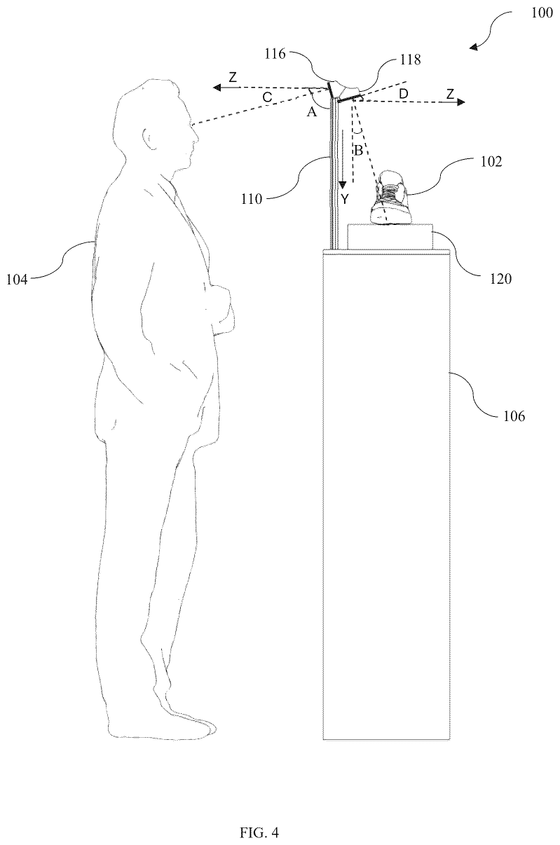

Referring to FIG. 4, a right side elevation schematic representation of the augment glass system 100 for tracking an angle A of the user coordinates and an angle B of an object coordinates is illustrated, in accordance with an embodiment of the disclosure. FIG. 4 is explained in conjunction with elements of FIG. 1, FIG. 2, and FIG. 3. The one or more processing units 302 may process the sensor data of the user sensor 116 and the object sensor 118 to track the angle A of the user coordinates and the angle B of the object coordinates. The angle A of the user coordinates may be dependent on the height of the hardware platform 106, the position of the user sensor 116, and the height of the user 104, and the distance of the user 104 from the user sensor 116. The angle A and angle B are measured in reference to Y plane defined in FIG. 2.

In another embodiment, the user sensor 116 is positioned at an angle C to the Z plane as described in FIG. 2. In particular, the user sensor 116 may be mounted on an angle adjustment hinge. The one or more processing units 302 may be configured to adjust the angle C of the user sensor 116, by manipulating the angle adjustment hinge. The one or more processing units 302 may adjust the angle to accurately capture the sensor data for the user coordinates and corresponding to the angle A of the user coordinates accordingly. The user sensor 116 may be adjusted manually or automatically via the one or more processing units 302. In an exemplary embodiment, the one or more processing units 302 may calculate the angle of tilt or pitch angle, at least based on the height of the hardware platform 106 and the height of the user coordinates. In another exemplary embodiment, the pitch angle of the active transparent display 110 may be relatively perpendicular to the line of sight of the user 104. The height of the active transparent display 110 and the user sensor 116 may be configured to the user coordinates such that the user 104 may look through the central region of the active transparent display 110 or at a direction and an orientation based on the use-case of the invention. In yet another exemplary embodiment, the user sensor 116 may be equipped with a wide angle lens (not shown). In another exemplary embodiment, the angle adjustment hinge associated with the user sensor 116 may be manipulated to adjust the digital content on the active transparent display 110.

In an embodiment, the object sensor 118 is positioned at an angle D to the Z plane as described in FIG. 2. The object sensor 118 may be mounted on an associated angle adjustment hinge. The one or more processing units 302 may be configured to adjust the angle D of the object sensor 118 to accurately capture the sensor data for the object coordinates and corresponding to the angle B of the object coordinates accordingly. The object sensor 118 may be adjusted manually or automatically via the one or more processing units 302. In an exemplary embodiment, the one or more processing units 302 may calculate the angle of tilt at least based on the height of the object platform 120 and the height of the object coordinates. Further, in another exemplary embodiment, the object sensor 118 may be equipped with a wide angle lens (not shown) on the camera. The angle C and angle D are measured in reference to a horizontal plane defined by the hardware platform 106.

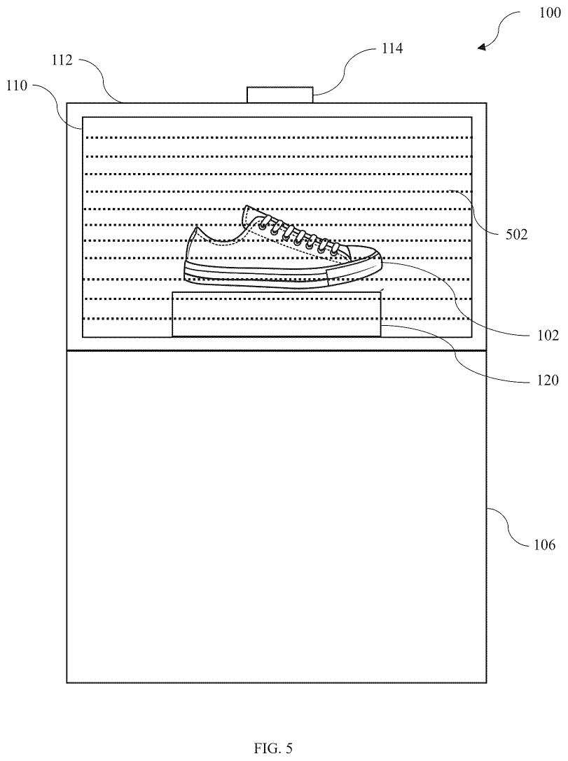

Referring to FIG. 5, a front elevation schematic representation of the augment glass system 100 showing the active transparent display 110 is illustrated, in accordance with an embodiment of the invention. FIG. 5 is explained in conjunction with elements of FIG. 1, FIG. 2, and FIG. 4. As shown in FIG. 5, the active transparent display 110 may include a plurality of diodes 502 arranged in an array. The plurality of diodes 502 may be equally spaced with respect to the active transparent display 110. The plurality of diodes 502 may emit light to display the digital content, i.e. project the digital content on the active transparent display 110, based on user coordinates. In another embodiment, the plurality of diodes 502 may be sandwiched between the glass, polycarbonate, acrylic, ionomer resin or any other suitable material that the active transparent display 110 is made of.

The one or more processing units 302 may be configured to enable controlling or operating of the plurality of diodes 502, for example via a user interface (not shown). In yet another embodiment, the plurality of diodes 502 may be installed in the frame 112. Light from the diodes 502 may be projected on the active transparent display 110 to display the digital content. Further, the object 102, which is optionally included, behind the active transparent display 110 may be easily visible (at an even increment for predetermined object coordinates) and positioned to maximize the digital content and interaction. In an exemplary embodiment, the digital content may contain 3D digital assets that visually enhance the object 102 along with synchronized peripheral elements, such as object lighting, secondary displays, audio, and robotics.

In an embodiment, the active transparent display 110 may define a surface to provide a touch interface for the user 104. The active transparent display 110 may act as a user interface to receive inputs from the user 104. As such, the user 104 may interact with the digital content displayed via the user interface. In another embodiment, the active transparent display 110 may overlay the digital content on the object 102. Further, the active transparent display 110 may provide an option to the user 104 for downloading the digital copy of the digital content. In some cases, the augment glass system 100 may provide a physical copy of the digital content.

The active transparent display 110 may have any shape or size and may be equipped with latest technologies such as MicroLED, OLED, or LED. In some embodiments, the active transparent display 110 may be protected by a frame 112. The frame 112 may include the custom sensor housing 114. The custom sensor housing 114 may be a modular attachment mounted on the active transparent display 110 or anywhere within the vicinity of the augment glass system 100. In some other embodiments, the frame 112 is not included with the active transparent display 110, and hence, the custom sensor housing 114 is installed on the hardware platform 106 or anywhere within the vicinity of the augment glass system 100.

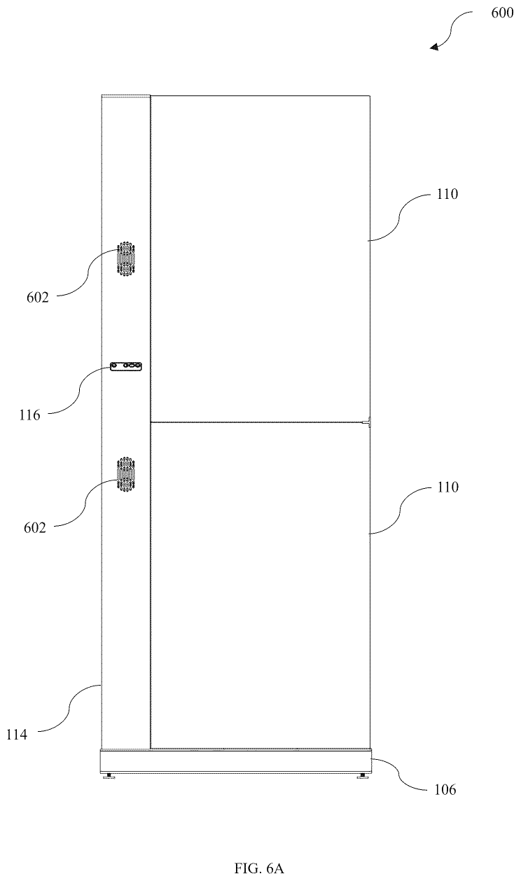

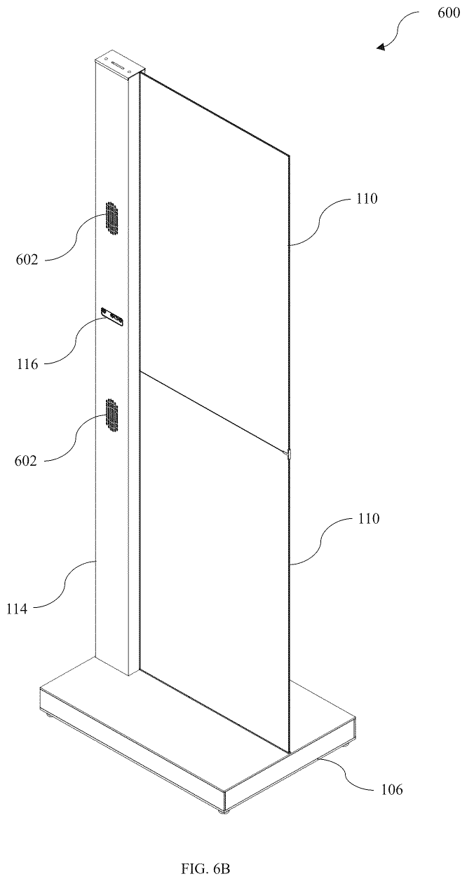

Now turning to FIG. 6A, a front elevation schematic representation of an augment glass system 600 showing the active transparent display 110 is illustrated, in accordance with an embodiment of the invention. FIG. 6B, a top right oblique perspective view of the augment glass system 600 showing the active transparent display 110. FIG. 6A and FIG. 6B are explained in conjunction to and discloses another/alternate embodiment of the augment glass system 100 disclosed in FIGS. 1-5.

The augment glass system 600 may include the custom sensor housing 114 installed on the hardware platform 106. The frame 112 may be positioned on both the sides of the active transparent display 110. The custom sensor housing 114 may include one or more sensors such as the user sensor 116 and the object sensor 118. The user sensor 116 is configured to detect the user 104 approaching, which is explained in detail in FIG. 2. The user sensor 116 may communicate electrically the presence of the user 104, to activate the digital content displayed via the active transparent display 110. Further, the custom sensor housing 114 may include an output device 602. The output device 602 may be configured to communicate output for the user 104, The output device 602 may be a speaker. Furthermore, the augment glass system 600 may include one or more active transparent display 110. The one or more active transparent display 110 may in combination display the digital content or may display separate independent digital content, using the one or more processing units 302.

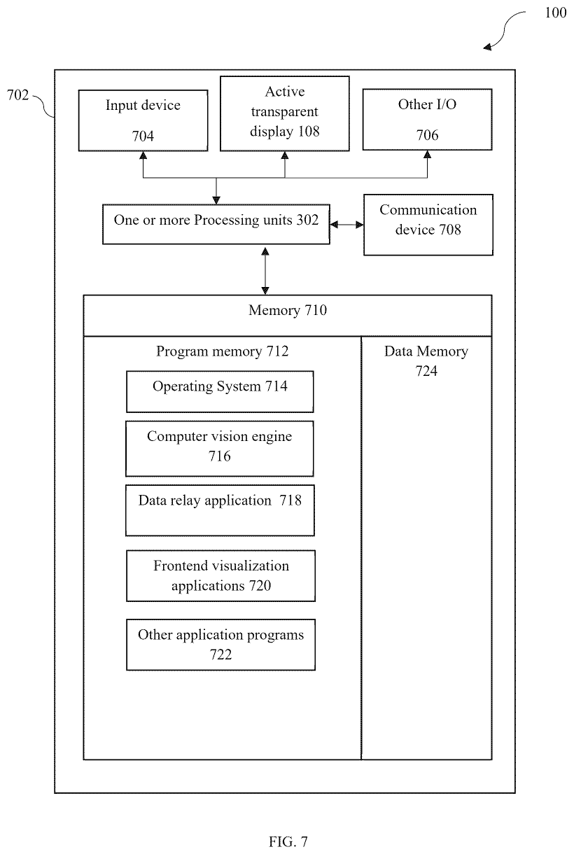

Now turning to FIG. 7, a block diagram of a processing circuitry 702 is illustrated, in accordance with an embodiment of the present invention. FIG. 7 is explained in conjunction with elements of FIG. 1, FIG. 2, FIG. 4, FIG. 5, FIG. 6A and FIG. 6B. The active transparent display 110 may implement the processing circuitry 702 for providing an artificial reality environment. In another embodiment, the processing circuitry 702 may include one or more processing units 302 (e.g., central processing units (CPUs), graphical processing units (GPUs), holographic processing units (HPUs), etc.) The one or more processing units 302 may be a single processing unit or multiple processing units in the active transparent display 110, the hardware platform 106, or distributed across multiple cloud servers.

In yet another embodiment, the processing circuitry 702 includes one or more input devices 704 that provide input to the one or more processing units 302, notifying them of actions. The actions can be mediated by a hardware controller that interprets the signals received from the input device 704 and communicates the information to the one or more processing units 302 using a communication protocol. Each input device 704 can include, for example, a camera, IR sensor, a motion sensor, an infrared sensor, an inductive sensor, a proximity sensor, an ultrasonic sensor, a photoelectric sensor, etc. Further, the input device 704 is configured to detect the user presence and the proximity of the user 104 to the augment glass system 100.

Further, the one or more processing units 302 may be coupled with other hardware devices, for example, with the use of an internal or external bus, such as a PCI bus, SCSI bus, or wireless connection. The active transparent display 110 may be used to display text and graphics. It may be noted that the active transparent display 110 may be separate from the input device 704. Examples of the active transparent display 110 may include an LCD display screen, an LED display screen, an OLED display screen, a MicroLED display screen, a projected, holographic, or augmented reality display (such as a heads-up display device or a head-mounted device), and so on. Furthermore, Other I/O devices 706 may also be coupled to the one or more processing units 302, such as a network chip or card, video chip or card, audio chip or card, USB, firewire or other external device, camera, printer, speakers, CD-ROM drive, DVD drive, disk drive, etc.

In an embodiment, the one or more processing units 302 may be coupled to a communication device 708 capable of communicating wirelessly or via a wired connection with other local computing devices or cloud servers. The communication device 708 may communicate with another device or a server through a network using, for example, TCP/IP protocols. For example, the one or more processing units 302 may utilize the communication device 708 to distribute operations across cloud servers.

In another embodiment, the one or more processing units 302 may have access to a memory 710, which may be contained in the augment glass system 100 or may be distributed across cloud servers or other external devices. Further, the memory 710 includes one or more hardware devices for volatile or non-volatile storage and may include both read-only and writable memory. For example, the memory 710 may include one or more of: random access memory (RAM), various caches, CPU registers, read-only memory (ROM), and writable non-volatile memory, such as flash memory, hard drives, floppy disks, CDs, DVDs, magnetic storage devices, tape drives, and so forth. The memory 710 may include a program memory 712 that stores programs and software, such as an operating system 714, a computer vision engine 716, a data relay application 718, a frontend visualization application 720 and other application programs 722. The memory 710 may also include a data memory 724 that may include augment data structures, surface data structures, augment context factor registrations, artificial reality environment information, other augment and/or surface support data, social graph data, configuration data, settings, user options, or preferences, which may be provided to the program memory 712 or any element of the augment glass system 100.

In yet another embodiment, the computer vision engine 716 functions as the perception layer, utilizing pre-trained models deployed on OAK-D Lite to implement a neural network inference architecture for optimized processing of spatial coordinates. It employs a pipeline architecture that allows for parallel processing of video streams, ensuring real-time responses through custom data processing utilities and utilizing Redis as a temporary data store for efficient inter-component communication. Further, the computer vision engine 716 may determine user coordinates and object coordinates.

In an embodiment, the data relay application 718 acts as a communication bridge, enabling real-time data transmission via a WebSocket server built on Flask Socket.IO and employing a publisher-subscriber model with Redis as the message broker.

In another embodiment, the frontend visualization application 720 focuses on rendering the augmented reality or mixed reality experience, utilizing React Three Fiber for 3D object representation and sophisticated perspective transformation mathematics to maintain accurate overlays of virtual content on their physical counterparts. Further, the frontend visualization application 720 may display the digital content on the active transparent display 110.

Together, these components facilitate an interactive experience where digital elements are aligned with real-world objects, allowing for a seamless blending of physical and digital realms without the need for special equipment, thereby enhancing user engagement and immersion in various applications.

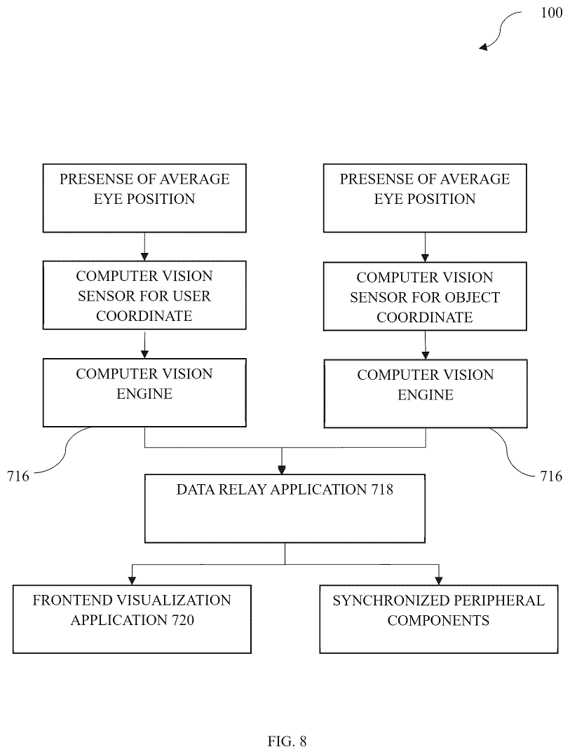

Now turning to FIG. 8, an information flow diagram of the augment glass 100 is illustrated, in accordance with an embodiment of the present invention. FIG. 8 is explained in conjunction with elements of FIG. 7. The augment glass system 100 via utilizing the processing circuitry 602, is configured to collect presence and average eye position of the user 104. The data related presence and average eye position may be collected by the user sensor 116. The computer vision sensor is configured to collect the sensor data related to the user coordinates. The computer vision engine 716 is configured to calculate the user coordinates at least based on the data collected by the computer vision sensor. Further, the data relay application 718 is configured as a communication bridge to provide the user coordinate to frontend visualization application 720.

In an embodiment, the augment glass system 100 via utilizing the processing circuitry 602, is configured to collect presence and object identification of the user 104. The data related presence and object may be collected by the user sensor 116. The computer vision sensor is configured to collect the object data related to the object coordinates. The computer vision engine 716 is configured to calculate the object coordinates at least based on the data collected by the computer vision sensor. Further, the data relay application 718 is configured as a communication bridge to provide the object coordinate to synchronized peripheral components such as lighting, audio, video, or robots, etc.

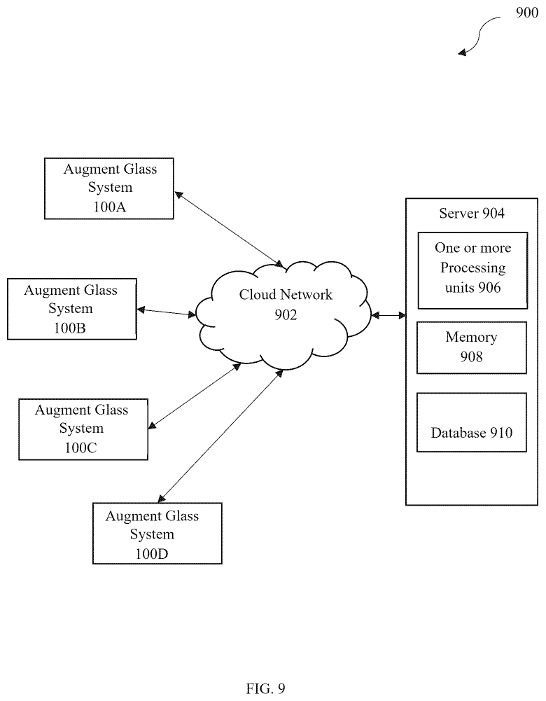

Now referring to FIG. 9, a block diagram of the augment glass system 100 communicating with a cloud network 902 is illustrated, in accordance with an embodiment of the invention. FIG. 9 is explained in conjunction with elements of FIG. 7 and FIG. 8. In another embodiment, the augment glass system 100 may be a part of an environment 900. The environment 900 may include one or more augment glass systems 100A-100D. The augment glass systems 100A-100D may operate in the environment 900 using logical connections through the cloud network 902.

In yet another embodiment, the augment glass systems 100A-100D may communicate a request to a server 904. The server 904 may coordinate fulfillment of those requests for the augment glass systems 100A-100D. Further, the server 904 may include one or more processing units 906, a memory 908, and a database 910. The server 904 may utilize the computing power of the one or more processing units 906 to render the digital content of the active transparent display 110 of the augment glass systems 100A-100D. For example, the server 904 may communicate with other servers to increase the computing resource. The one or more processing units 906 may access the database 910 for relevant information as requested by the augment glass systems 100A-100D. In an embodiment, the database 910 may store the digital content that can be accessed at least on the request of the user 104.

In another embodiment, the cloud network 902 may be a local area network (LAN), a wide area network (WAN), a mesh network, a hybrid network, or other wired or wireless networks. The cloud network 902 may be the Internet or some other public or private network. The augment glass system 100A-100D may be connected to the cloud network 902 through a network interface, such as by wired or wireless communication. While the connections between the cloud network 902 and the server 904 are shown as separate connections, this connection may be any kind of local, wide area, wired, or wireless network.

The augment glass system 100 introduces an innovative and immersive way for engaging with digital content alongside physical environments. By leveraging the active transparent display 110 advanced display technology, sensor technology, processing circuitry 702, combined with optional synchronized peripheral elements, the augment glass system 100 offers a sophisticated approach to viewing 3D digital assets. It paves the way for a groundbreaking category of augmented reality and mixed reality that eliminates the need for cumbersome head-mounted displays or personal devices, allowing users to seamlessly integrate digital experiences into their real-world surroundings.

It should be understood that the foregoing description is only illustrative of the aspects of the disclosed embodiments. Various alternatives and modifications may be devised by those skilled in the art without departing from the aspects of the disclosed embodiments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of components and/or functions than those explicitly described above are also contemplated as may be set forth in some of the appended claims. Although specific terms are employed herein, they are used in a generic and descriptive sense only and not for purposes of limitation.

The claimed invention is:

1. A method to dynamically adjust a digital content in view of a user, wherein the method comprising:
capturing sensor data of the user via a user sensor and an object via an object sensor,
processing the sensor data obtained from the user sensor and the object sensor,
determining user coordinates and object coordinates via one or more processing units, and
displaying the digital content on an active transparent display.

2. The method of claim 1, wherein the user sensor and the object sensor include an infrared camera or a face mapping module.

3. The method of claim 1, wherein the one or more processing units compile the received sensor data to identify user details and object details.

4. The method of claim 3, wherein the user coordinates further include:
determining by calculating the distance between a global coordinate and the user,
determining an average user point coordinate based on a left eye and a right eye of the user,
wherein the average user point coordinate is the user coordinates for tracking the user.

5. The method of claim 3, wherein the object coordinates further include:
determining by calculating the distance between a global coordinate and the object,
determining an average object point coordinate based on height, width, and length of the object,
wherein the average object point coordinate is the object coordinates for tracking the object.

6. The method of claim 1, wherein the one or more processing units further include:
calculating an angle of tilt or pitch angle at least based on a height of a hardware platform and a height of the user coordinates,
orienting the digital content at least based on the real-time user coordinates, and
displaying the digital content on the active transparent display.

7. The method of claim 1, wherein the active transparent display comprises:
a plurality of diodes for projecting the digital content based on user coordinates, and
a touch interface for the user.

8. An augment glass system to dynamically adjust a digital content in view of a user, wherein the augment glass system comprises:
an active transparent display;
a custom sensor housing, wherein the custom sensor housing includes:
a user sensor to capture sensor data of the user; and
an object sensor to capture sensor data of an object;
one or more processing units configured for:
processing sensor data obtained from the user sensor and the object sensor,
determining user coordinates and object coordinates, via a computer vision engine, and
displaying the digital content on the active transparent display via a frontend visualization application.

9. The system of claim 8, wherein the custom sensor housing is a modular attachment mounted on the active transparent display.

10. The system of claim 8, wherein the user sensor and the object sensor include a camera to capture data of the user and the object.

11. The system of claim 8, wherein the user coordinates:
determine by calculating the distance between a global coordinate and the user,
determine an average user point coordinate based on a left eye and a right eye,
wherein the average user point coordinate is the user coordinates for tracking the user.

12. The system of claim 8, wherein the object coordinates:
determine by calculating the distance between a global coordinate and the object,
determine an average object point coordinate based on height, width, and length of the object,
wherein the average object point coordinate is the object coordinates for tracking the object.

13. The system of claim 8, wherein the one or more processing units:
calculate an angle of tilt or pitch angle at least based on a height of a hardware platform and a height of the user coordinates,
orient the digital content at least based on the real-time user coordinates, and
display the digital content on the active transparent display.

14. The system of claim 8, wherein the active transparent display comprises:
a plurality of diodes for projecting the digital content on the active transparent display based on user coordinates, and
a touch interface for the user.

15. The system of claim 8, further comprises a processing circuitry includes one or more processing units communicating via a communication device to a cloud network.

16. The system of claim 15, wherein the cloud network includes a server for processing the rendering of the digital content to display on the active transparent display.

17. An augment glass system for dynamically adjusting a digital content in view of a user, the augment glass system comprising:
a hardware platform;
an active transparent display operatively coupled to the hardware platform;
a custom sensor housing, the custom sensor housing including:
a user sensor configured to capture sensor data of the user; and
an object sensor configured to capture sensor data of an object;
one or more processing units operatively coupled to the user sensor and the object sensor configured to:
process the sensor data of the user obtained from the user sensor to determine real-time user coordinates using a computer vision engine;
process the sensor data of the object obtained from the object sensor to determine real-time object coordinates using the computer vision engine;
calculate an angle of tilt or pitch angle based at least on a height of the hardware platform and a height of the user coordinates; and
dynamically adjust and orient the digital content displayed on the active transparent display based on real-time user coordinates in response to changes in the user coordinates.

18. The augment glass system of claim 17, wherein the hardware platform further comprises one or more active transparent displays operatively coupled to the hardware platform, and wherein the one or more processing units are configured to display the digital content selected from the group consisting of:
(i) displaying the digital content on the one or more active transparent displays; and (ii) displaying a plurality of digital content independently on the plurality of active transparent displays.

19. The augment glass system of claim 17, wherein the active transparent display further comprises a processing circuitry including:
one or more processing units configured to communicate via a communication device to a cloud network;
wherein the cloud network includes a server for processing the rendering of the digital content to display on the active transparent display.

20. The augment glass system of claim 17, further comprising:
a plurality of augment glass systems for dynamically adjusting the digital content, each augment glass system including:
a processing circuitry including one or more processing units;
wherein the processing circuitry of each augment glass system is configured to communicate with at least one other processing circuitry of the plurality of augment glass systems via a communication device to a cloud network;
wherein the cloud network includes a server for processing the rendering of the digital content to display on the active transparent display of each augment glass system.
